(19) United States
(12) Patent Application Publication
(10) Pub. No.: US 2026/0168481 A1
(43) Pub. Date: Jun. 18, 2026

(54) METHOD FOR EVALUATING A PERFORMANCE OF A WIND TURBINE

(71) Applicant: Wobben Properties GmbH, Aurich (DE)

(72) Inventors: Fernando BARROSO, Viana Do Castelo (PT); Gilles BOESCH, Montreal (CA); Marvin IWWERKS, Hamburg (DE)

(21) Appl. No.: 19/415,541

(22) Filed: Dec. 10, 2025

(30) Foreign Application Priority Data
Dec. 12, 2024 (EP) 24219341.5

(51) Int. Cl. F03D 17/00

(52) U.S. Cl. CPC F03D 17/026; F03D 17/007; F05B 2260/80

(57) ABSTRACT

The present disclosure is directed to methods, systems, and computer-readable media for evaluating performance of a wind turbine using, a training data set. In one aspect, a method includes clustering a plurality of wind turbines with a trained machine learning algorithm into a plurality of clusters of wind turbines, acquiring the at least one site specific parameter for the wind turbine, identifying a specific cluster from the plurality of clusters with comparable conditions to the wind turbine based on the at least one site specific parameter of the wind turbines comprised in the specific cluster and the at least one site specific parameter of the wind turbine, determining a cluster performance index of the specific cluster based on the at least one power production parameter of the wind turbines comprised in the specific cluster, evaluating the performance of the wind turbine.

### TECHNICAL FIELD

The present disclosure relates to a method for evaluating a performance of a wind turbine, a computer program and a training data set.

### BACKGROUND

Wind turbines are known. They provide a popular source for green, sustainable power production. For this, wind turbines are often arranged in wind farms comprising a plurality of wind turbines. Apart from these power-plant-like assemblies in wind farms, wind turbines provide also the possibility to evolve from a centralized energy supply that requires long power lines to reach all inhabited regions, to a more decentralized energy supply. For example, only a few wind turbines suffice to supply small villages or towns, that when located next to the small village or town make long power lines obsolete.

In order to plan reliable power supply with wind turbines, the power production of a wind turbine has to be reliable. A parameter to monitor the power production of a wind turbine is the Annual Energy Production, AEP. This performance indicator provides a summary of the power produced by the wind turbine over the range of one year. In specific, a plurality of power curves, that each describe the actual power output of the wind turbine at a different time, are summarized in the AEP.

Deviations in these power curves may temporarily affect the power supply, which in an above described decentralized energy supply may cause undesired blackouts. Therefore, persistent power curves of a wind turbine and a good performance of the wind turbine are desirable.

In wind farms, the individual performance of each wind turbine can be easily determined by comparing it to the performance of the other wind turbines. Since all wind turbines of a wind farm operate under the same conditions, besides wake effects, underperforming wind turbines may be easily detected. However, regarding locations where only a few wind turbines, in specific only one wind turbine, or several wind turbines with different configurations are arranged, the detection of an underperforming wind turbine is more difficult since there are no other similar wind turbines to compare to.

### SUMMARY

Against this background, the present disclosure was faced with the task to provide means to reliably detect underperforming wind turbines, in specific, underperforming wind turbines that are not part of a wind farm.

According to a first aspect of the present disclosure, a method for evaluating a performance of a wind turbine is provided, comprising the following steps: acquiring at least one power production parameter and at least one site specific parameter for each of a plurality of wind turbines for each of a plurality of days, preparing a dataset based on the acquired parameters, training a machine learning algorithm to cluster the plurality of wind turbines into a plurality of clusters of wind turbines with comparable conditions based on the dataset, in specific based on the at least one site specific parameter, each of the plurality of clusters of wind turbines comprising at least two wind turbines, clustering the plurality of wind turbines with the trained machine learning algorithm into a plurality of clusters of wind turbines, acquiring the at least one site specific parameter for the wind turbine, identifying a specific cluster from the plurality of clusters with comparable conditions to the wind turbine based on the at least one site specific parameter of the wind turbines comprised in the specific cluster and the at least one site specific parameter of the wind turbine, determining a cluster performance index of the specific cluster based on the at least one power production parameter of the wind turbines comprised in the specific cluster, acquiring the at least one power production parameter of the wind turbine and determining a wind turbine performance index of the wind turbine based on the at least one power production parameter of the wind turbine, evaluating the performance of the wind turbine by comparing the wind turbine performance index of the wind turbine to the cluster performance index of the specific cluster.

The method may, for example, be executed by one or more computers that comprise in specific one or more input interfaces to receive data directly or indirectly from one or more wind turbines, such as sensor data measured by real physical sensor arranged at the one or more wind turbines.

The step of acquiring at least one power production parameter and at least one site specific parameter for each of a plurality of wind turbines for each of a plurality of days comprises for example receiving and/or determining and/or looking up and/or selecting and/or reading from a memory at least one power production parameter and at least one site specific parameter for each of a plurality of wind turbines for each of a plurality of days.

A power production parameter is a parameter that indicates the power production of a wind turbine, for example a mean power production over one or more hours or a day. A site specific parameter indicates conditions the wind turbine is faced with at the site of the wind turbine that is the location, where the wind turbine is arranged.

In one example, at least one power production parameter is acquired for every mode, the wind turbine is operated with. These modes may for example be a power optimized mode and/or a noise optimized mode and/or a safety optimized mode that prevents the wind turbine from taking damage, for example due to extensive loads acting on the wind turbine.

The at least one power production parameter and at least one site specific parameter is acquired for each of the plurality of wind turbines for each of a plurality of days in order to provide data that represents the real conditions each of the wind turbines are operated in. If data from only one day is acquired, the data may be misleading, since on this day extraordinary conditions could have occurred. By acquiring data from a plurality of days, that means at least 3 days, the likeliness of extraordinary conditions is reduced and the reliability and truthfulness of the data increased.

In one example, data covering the last year, for example the last two years of operation of each of the plurality of wind turbines, may be utilized.

The step of preparing a dataset based on the acquired parameters comprises, for example, summarizing and/or sorting and/or converting data of the acquired parameters in order to provide a dataset based on which a machine learning algorithm may be trained successfully.

In one example, data from a wind turbine is added to the dataset for each mode the wind turbine is operated in, for which data is available. For example, a wind turbine running in power optimized mode during day and noise optimized mode during night may be input into the dataset as two independent turbines: One with the operating characteristics of the power optimized mode, and one with the operating characteristics of the noise optimized mode.

The step of preparing a dataset may include steps such as preprocessing data and/or a principal component analysis and/or optimization of the dataset based on for example the principal component analysis.

The step of training a machine learning algorithm to cluster the plurality of wind turbines into a plurality of clusters of wind turbines with comparable conditions based on the dataset, in specific based on the at least one site specific parameter, each of the plurality of clusters of wind turbines comprising at least two wind turbines, comprises the steps of acquiring an untrained machine learning algorithm, providing a trained machine learning algorithm and additional other steps like storing the trained machine learning algorithm in a memory.

A machine learning, ML, algorithm is a set of rules and/or processes used by an artificial intelligence, AI, system to conduct tasks, for example to discover new data insights and patterns, or to predict output values from a given set of input variables. Algorithms enable machine learning to learn.

The training of a machine learning algorithm may for example be described by the following: A paper from UC Berkeley breaks out the learning system of a machine learning algorithm into three main parts.
1) A decision process: In general, machine learning algorithms are used to make a prediction or classification. Based on some input data, which can be labeled or unlabeled, the algorithm will produce an estimate about a pattern in the data.
2) An error function: An error function evaluates the prediction of the model underlying the machine learning algorithm. If there are known examples, an error function can make a comparison to assess the accuracy of the model.
3) A model optimization process: If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized.

Unlike supervised learning, unsupervised learning uses unlabeled data. From that data, the algorithm discovers patterns that help solve clustering or association problems. This is particularly useful when subject matter experts are unsure of common properties within a data set.

The trained ML algorithm provided by a method according to the present disclosure is able to cluster the plurality of wind turbines into a plurality of clusters of wind turbines with comparable conditions. Based on the dataset and in specific based on the at least one site specific parameter, the comparable conditions of wind turbines comprised in one cluster may for example be a comparable, in specific same, wind speed, in specific average wind speed, and/or turbulence intensity, in specific average turbulence intensity, and/or wind shear, in specific average wind share, and/or air density and/or humidity, in specific average rain/snow fall, at the respective sites of the wind turbines.

Since the dataset may include different data of a wind turbine relating to different operating modes of the wind turbine as independent wind turbines, it is possible that data from one wind turbine appears in different clusters, in other words that a wind turbine may be assigned to more than one cluster depending on the number of operating modes for which data is present in the dataset. Like this, each clusters will be formed by similar wind turbines running similar operating modes, creating a more representative group of wind turbines. This will improve the comparison of wind turbines to the clusters.

In an embodiment, different clusters of wind turbines may for example be:
wind turbines operated close to sea level in maritime climate with a power optimized mode,
wind turbines operated close to inhabited regions in continental climate with a noise optimized mode,
wind turbines operated in very wind turbulent regions near mountains operated in safety optimized modes to prevent damage to the wind turbine,
wind turbines operated in remote dry regions,
wind turbines operated in forests,
wind turbines operated in very cold regions faced with challenges regarding icing of rotor blades operated in safety optimized modes.

However, these are very simplified examples in order to explain the intention behind the clustering of wind turbines. A clustering performed by a trained ML algorithm according to a method according to the present disclosure is expected to provide much more complex cluster structures.

The step of clustering the plurality of wind turbines with the trained machine learning algorithm into a plurality of clusters of wind turbines comprises the step of providing the trained ML algorithm with data of the plurality of wind turbines, such as the at least one power production parameter and at least one site specific parameter for each of a plurality of wind turbines for each of a plurality of days, as input, and the step of providing, by the trained ML algorithm, a plurality of clusters of wind turbines with comparable conditions as output.

In one example, the input of the trained ML algorithm is the at least one power production parameter and at least one site specific parameter for each of a plurality of wind turbines for each of a plurality of days. Alternatively, the input may also be the dataset prepared based on the acquired parameters in a previous step of a method according to the present disclosure.

The step of acquiring the at least one site specific parameter for the wind turbine comprises for example receiving and/or determining and/or looking up and/or selecting and/or reading from a memory at least one site specific parameter for the wind turbine. The wind turbine is thereby the wind turbine which performance is to be evaluated by the method according to the present disclosure.

The step of identifying a specific cluster from the plurality of clusters with comparable conditions to the wind turbine based on the at least one site specific parameter of the wind turbines comprised in the specific cluster and the at least one site specific parameter of the wind turbine, comprises for example comparing the at least one site specific parameter of the wind turbine to the at least one site specific parameter of the wind turbines comprised in a specific cluster, in specific for every cluster of the plurality of clusters, and determining a specific cluster, which at least one site specific parameter of the wind turbines comprised in the cluster matches the at least one site specific parameter of the wind turbine best. The best matching at least one site specific parameter of the wind turbines of a cluster indicates comparable conditions at the site of the wind turbines.

The above step of identifying a specific cluster can be executed by a trained machine learning algorithm.

The step of determining a cluster performance index of the specific cluster based on the at least one power production parameter of the wind turbines comprised in the specific cluster, comprises for example calculating and/or looking up and/or selecting and/or reading from a memory a cluster performance index of the specific cluster based on the at least one power production parameter of the wind turbines comprised in the specific cluster. The cluster performance index is a parameter that indicates for example a mean power production of the wind turbines of a cluster based on the at least one power production parameter of the wind turbines.

In an embodiment, a cluster performance index of a cluster, in specific the specific cluster, is for example determined in the following steps:
1 Create a bin averaged wind speed vs power curve for each wind turbine in the cluster;
2. Normalize the binned power curve by dividing the average power by the wind turbine maximum operating power;
3. Bin average all the cluster wind turbine normalized curve, obtaining a cluster average power curve;
4. Calculate the AEP for the cluster average power curve as cluster average annual energy production (AEPᵣ);
5. Store the model, in specific the AEPᵣ, for future performance comparison with the wind turbines of the cluster.

In this example, the average wind speed is acquired as site specific parameter and the power curve is acquired as or determined based on the power production parameter of each of the plurality of wind turbines. The AEPᵣ is in this example the performance index of the cluster.

The step of acquiring the at least one power production parameter of the wind turbine and determining a wind turbine performance index of the wind turbine based on the at least one power production parameter of the wind turbine, comprises for example receiving and/or determining and/or looking up and/or selecting and/or reading from a memory the at least one power production parameter of the wind turbine and for example calculating and/or looking up and/or selecting and/or reading from a memory a wind turbine performance index of the wind turbine based on the at least one power production parameter of the wind turbine. The wind turbine performance index is a parameter that indicates for example a mean power production of the wind turbine based on the at least one power production parameter of the wind turbine.

In an embodiment, a wind turbine performance index of the wind turbine is for example determined in the following steps:
1. Calculate a binned power curve for the wind turbine for a specific time range defined by the acquired data;
2. Calculate the AEP for the binned power curve of the wind turbine (AEPₘ);
3. Calculate the performance ratio (PR) of the wind turbine annual energy production AEPₘ compared to the cluster average annual energy production AEPᵣ (AEPₘ/AEPᵣ);

In this example the binned power curve is calculated based on the at least one power production parameter acquired for the wind turbine and the AEPₘ is the wind turbine performance index.

The third step of calculating the performance ratio (PR) of the wind turbine annual energy production AEPₘ compared to the cluster average annual energy production AEPᵣ, is an example for an embodiment of the step of evaluating the performance of the wind turbine by comparing the wind turbine performance index of the wind turbine to the cluster performance index of the specific cluster of a method according to the present disclosure.

The step of evaluating the performance of the wind turbine by comparing the wind turbine performance index of the wind turbine to the cluster performance index of the specific cluster, comprises for example determining which of the wind turbine performance index and the cluster performance index has a higher value, in specific, determining a difference between the wind turbine performance index and the cluster performance index. In one example, the evaluating step is performed based on such a determination. If the wind turbine performance index is higher than the cluster performance index, the performance of the wind turbine is for example evaluated as very good or above average. In case the wind turbine performance index is lower than the cluster performance index, the performance of the wind turbine is for example evaluated as low or below average. In one example, the evaluation is based on a difference between both performance indices. In another example, thresholds in this difference are defined. These threshold define for example for which values of the difference between the both performance indices the performance of the wind turbine is evaluated as for example very good, good, average, low, very low.

In one example, the present disclosure provides a method for evaluating the performance of a wind turbine comprising the following steps: Acquiring the at least one site specific parameter for the wind turbine, Acquiring a plurality of clusters of wind turbines that were clustered by a machine leaning algorithm trained according to the first aspect of the present disclosure, Identifying a specific cluster from the plurality of clusters with comparable conditions to the wind turbine based on the at least one site specific parameter of the wind turbines comprised in the specific cluster and the at least one site specific parameter of the wind turbine, Determining a cluster performance index of the specific cluster based on the at least one power production parameter of the wind turbines comprised in the specific cluster, Acquiring the at least one power production parameter of the wind turbine and determining a wind turbine performance index of the wind turbine based on the at least one power production parameter of the wind turbine, Evaluating the performance of the wind turbine by comparing the wind turbine performance index of the wind turbine to the cluster performance index of the specific cluster.

In this embodiment, the method steps are repeatedly executed, in specific with different values for the at least one site specific parameter referring to different wind turbines and different values for the at least one power production parameter referring to different wind turbines, without repeating the steps of training the machine learning algorithm and clustering the plurality of wind turbines with the trained machine learning algorithm into a plurality of clusters of wind turbines. For example, the performance of two or more different wind turbines with different values for the at least one site specific parameter and/or the at least one power performance parameter may be evaluated without retraining and reclustering in between. The present disclosure therefore also refers to methods that evaluate the performance of a wind turbine based on acquired clusters of wind turbines that were previously clustered by a trained ML algorithm.

In one example, the clustering of the plurality of wind turbines by the trained ML algorithm is repeated every year, such as every 6 months, every 3 months, every month, etc.

In one aspect of the present disclosure, the machine learning algorithm is an unsupervised machine learning algorithm.

Unlike supervised ML algorithms are advantageous when dealing with unlabeled data. From that data, the unsupervised ML algorithm, in contrast to other ML algorithms, is able to discover patterns that help solve clustering or association problems. This is particularly useful when subject matter experts are unsure of common properties within a data set, which is the case in this clustering of wind turbines. The unsupervised ML algorithm therefore provides a tool to find correlations and patterns among the plurality of wind turbines that would remain hidden for an expert. These optimized clusters enable an optimized comparison of the wind turbine to be evaluated to the plurality of wind turbines.

An unsupervised ML algorithm is therefore beneficial regarding the underlying task of the present disclosure.

In a variation of the above example, the machine learning algorithm is one of a k-means algorithm, a density based spatial clustering of applications with noise, an agglomerative clustering, and a bisecting k-means algorithm.

K-means is a partitioning clustering method as an example for clustering methods. This identifies groups within data without labels into different clusters by finding groups of data which are similar to one another. The name “k-means” come from the $k$ centroids that it uses to define clusters. A point is assigned to a particular cluster if it is closer to that cluster's centroid than any other centroid. The k-means algorithm forms k∈N cluster and is defined for example as:
1. Select k data points at random as cluster centre cᵢ, i=0, . . . , k.
2. While data points change cluster:
   a. For every data point, calculate the distance to every cluster centre.
   b. Assign the data point to the cluster with the nearest centre.
   c. Calculate new cluster centre cᵢ for every cluster, taking the mean value of every feature.

A DBSCAN Algorithm (Density Based Spatial Clustering of Applications with Noise) is a density based clustering algorithm. It calculates the clusters according to the density of the data points and does not take the number of clusters as a parameter. Instead, it uses the distance around a point and the radius ε∈R⁺, to determine if two points are in a neighbourhood. It also uses the number of data points in this neighbourhood to determine if a data point is a core point of a cluster or not. Setting the distance parameter & and the minimum samples (minPoints∈N) in the neighbourhood n is not easy and is based on the analysis of the data prior to being set.

The DBSCAN Algorithm is defined for example as:
1 Set all data points as unlabelled.
2. Cluster ID cᵢ, i=0, . . . .
3 For all x∈ dataset:
   a. If x unlabelled:
      i. set={y∈ dataset|dist(x,y)≤ε}.
      ii. If |set|≤min Points labelled x as noise: cᵢ=−1.
      iii. Else, label all y∈ set with cᵢ.
         1. For all y∈ set:
         a. set₂={z∈ dataset|dist(x,y)≤ε}.
         b. If |set₂|≥minPoints:
         i. For all z∈ set₂:
         1. If z unlabelled add to set and label with cᵢ.
         2. i=i+1.

The Agglomerative Clustering algorithm is a hierarchical clustering algorithm. Hierarchical clustering groups data into a tree of clusters. Hierarchical clustering begins by treating every data point as a separate cluster. Then, it repeatedly executes these steps: 1) identify the two clusters which can be closest together, and 2) merge the two maximum comparable clusters. These steps continue until all the clusters are merged together. Agglomerative Clustering uses a bottom up approach to fuse data points to larger clusters. It begins to set every data point into its own cluster and then combines cluster that are close together.

The Agglomerative Clustering algorithm is defined for example for a dataset with n data points as:
1. Assign every data point to its own cluster cᵢ∈C, Number of cluster: n
2. While n≥k:
   a. ∀cᵢ∈C, calculate the distance to every cluster.
   b. Merge the two cluster with the smallest distances.
   c. n=n−1.

It can use four different approaches to calculate the distance between the clusters: average linkage, complete linkage, single linkage and ward. Average linkage uses the average distance between the data points of the clusters. Complete linkage uses the greatest distance between two points of the cluster. Single linkage uses the smallest distance between two points of the cluster. Ward uses the variance inside a cluster to determine which fusion of the cluster increases the variance the less.

A bisecting k-means algorithm is another hierarchical algorithm, it uses the method of hierarchical clustering and the k-means algorithm. It progressively splits one cluster into two until a set number of clusters k∈N is reached. The bisecting k-means has for example two different strategies in the SKLearn library:
1. Largest Cluster: Selects the cluster with the most points to split.
2. Biggest Inertia: Selects the cluster with the biggest sum of squared errors within.
To get cluster of similar size it is better to pick the largest cluster strategy, it also is faster than the second strategy, because it only takes the size of the cluster into account. The bisecting k-means algorithm is defined for example as:
1. While number of cluster n<k
   a. Select a parent cluster C selected by strategy.
   b. Split C into C₁ and C₂ using k-means.

In one aspect of the present disclosure, the at least one site specific parameter comprises information about at least one of: a site height, a wind distribution at a site, an average air density at a site, an average temperature at a site, and an average turbulence intensity at a site.

The site height is for example the height of the location at which the wind turbine is arranged above sea level. Alternatively the site height is for example defined as the height of the nacelle of the wind turbine above sea level. The wind distribution comprises for example different wind directions and/or different wind speeds and/or different wind shear that occur at the site.

In one aspect of the present disclosure, the step of training the machine learning algorithm comprises the step of: optimizing a cluster size of the plurality of clusters of wind turbines.

The cluster size is important for the ML algorithm, for example for the calculation of model power curves, to ensure that an ideal behaviour of the wind turbines that are part of a cluster is represented through the mean value of the power curves. The three algorithms k-means, agglomerative clustering and bisecting k-means for example take the amount of cluster as a parameter, the DBSCAN algorithm, takes minimal samples and the radius as parameter.

In an embodiment, for each algorithm, the amount of cluster and minimal samples is, for example, trained for 2 to 46 cluster. In addition different distance functions, Euclidean, Manhattan and Cosine distance, are used in this embodiment to calculate the cluster.

In one aspect of the present disclosure, the method further comprises the step of: evaluating the clusters of wind turbines generated by the machine learning algorithm, and repeating the step of training the machine learning algorithm until the clusters of wind turbines generated by the machine learning algorithm satisfy predetermined requirements.

In specific, these steps are comprised in the step of training the ML algorithm. In this case the step of repeating the step of training the ML algorithm is replaced by a step of repeating generating the plurality of clusters of wind turbines.

The step of evaluating the clusters of wind turbines comprises for example a comparison of the clusters with the predetermined requirements. In case the clusters do not satisfy the predetermined requirements, the step of repeating the step of training the ML algorithm is executed.

The predetermined requirements are for example requirements regarding cluster size and/or threshold of other optimization parameters.

In one aspect of the present disclosure, the step of evaluating the performance of the wind turbine by comparing the wind turbine performance index of the wind turbine to the cluster performance index of the specific cluster comprises the step of: determining a variation of the wind turbine performance index of the wind turbine to the cluster performance index of the specific cluster.

The step of determining a variation of the wind turbine performance index of the wind turbine to the cluster performance index of the specific cluster comprises for example calculating and/or looking up and/or selecting and/or reading from a memory a variation of the wind turbine performance index of the wind turbine to the cluster performance index of the specific cluster. In case the variation is calculated, the calculation is for example a subtraction.

In a variation of the above example, the method further comprises the step of: generating a signal, in specific a flag or an alarm, if the variation of the wind turbine performance index of the wind turbine to the cluster performance index of the specific cluster is higher than a predetermined threshold value.

The predetermined threshold value is a threshold value for the determined variation of the wind turbine performance index of the wind turbine to the cluster performance index of the specific cluster. For example, if the variation is determined as a subtraction of the wind turbine performance index of the wind turbine from the cluster performance index of the specific cluster, a predetermined threshold value of 0 would cause the generation of a signal if the wind turbine performance index of the wind turbine deviates from the cluster performance index of the specific cluster. In one example, different flags are generated dependent on whether the variation is positive, that is when the wind turbine performance index of the wind turbine is lower than the cluster performance index, or negative, that is when the wind turbine performance index of the wind turbine is higher than the cluster performance index. Better performance of the wind turbine is good and in some exemplary embodiments there is then no need for an alarm, while a low performance of a wind turbine is undesirable and therefore the performance of the wind turbine may be monitored for generation of an alarm.

The predetermined threshold value is for example set as a fixed value or as a percentage value of the respective cluster performance index. Alternatively, the predetermined threshold value is set as a function that determines a threshold value for the specific cluster.

In an example of this variation of the above example these steps are implemented as:
1. Calculate performance ratio statistics for the selected group, so thresholds can be calculated. Thresholds are defined by two methods:
   a. Fixed Method
   b. Tuckey's Method
2. Evaluate the threshold exceedances and create Boolean columns with the results:
   a. If the threshold is exceeded set it to True, else;
   b. Set it to False
3. For each threshold limit flag, create a counter that, with the ascending ordered data of each wind turbine:
   a. For each True value, increase the counter by 1;
   b. For each False value, decrease the counter by 1;
   c. If the counter is <0, it shall remain 0.
4. When the counter exceeds 10, an alert shall be generated.

In the above example, a second threshold is predetermined as threshold for the amount of flags set by the step of generating a signal, in this example generating a flag. This second predetermined threshold is 10 in this example. An alarm is then generated, when the number of successively generated True flags is greater than the second predetermined threshold.

With the counting operation of the above example, alerts are created for performance deviating wind turbines. In this example an exceedance of the thresholds of at least 10 days is necessary to generate an alert. Ensuring that the counter isn't smaller than 0 makes the system equally reactive even after a long period of normal operation.

In a further variation of the above example, the predetermined threshold value is a cluster dependent threshold value that is preset for each of the plurality of clusters of wind turbines as a function, such as a specific percentage (e.g., 5%), of a cluster performance index of the respective cluster.

For example, with a 5% cluster dependent threshold value, a signal is generated if the wind turbine performance index of the wind turbine deviates from the cluster performance index by 5% of the cluster performance index. Besides a flat value of for example, 10% or 7% or 5% or 3% or 1% of the cluster performance index, the cluster dependent threshold value may also be defined as another function of the cluster performance index, for example as a percentage value of the cluster performance index like above, however the percentage value shifts depending on the cluster performance value, in specific decreases, with increasing cluster performance value.

In one aspect of the present disclosure, the method further comprises the steps of: acquiring at least one configuration parameter of each of the plurality of wind turbines for each of the plurality of days, training a machine learning algorithm to cluster the plurality of wind turbines into a plurality of clusters of wind turbines with comparable conditions based on at least the at least one configuration parameter, each of the plurality of clusters of wind turbines comprising at least two wind turbines, clustering the plurality of wind turbines with the trained machine learning algorithm into a plurality of clusters of wind turbines, acquiring the at least one configuration parameter for the wind turbine, Identifying a specific cluster from the plurality of clusters with comparable conditions to the wind turbine based on the at least one configuration parameter of the wind turbines comprised in the specific cluster and the at least one configuration parameter of the wind turbine.

In this embodiment a method is describes that uses at least one configuration parameter of the wind turbines analogous to the above at least one site specific parameter in addition to the at least one site specific parameter. The training step and the clustering step may be performed considering the at least one site specific parameter and the at least one configuration parameter of the wind turbines. In other words, the at least one configuration parameter adds at least one dimension to the dataset, the training of the ML algorithm and the clustering. The clustering of the wind turbines is thus more detailed, since not only site conditions of the wind turbines are considered but also configurations. In a simplified example, a cluster comprising wind turbines with comparable conditions at the sites is split into two or more clusters according to comparable configurations of the wind turbines, clustering all wind turbines with comparable site conditions and comparable configurations in new, smaller clusters. This improves the accuracy of the comparison of the wind turbine with a cluster.

Even though the steps of acquiring, training, clustering, acquiring and identifying regarding the at least one configuration parameter are written separately from the respective steps regarding the at least one site specific parameter, they are in an alternative embodiment comprised in the respective steps regarding the at least one site specific parameter. These steps are then taking into account both, the at least one site specific parameter and the at least one configuration parameter. In this case, there is for example only one training step in a method according to the present disclosure that considers the at least one site specific parameter as well as the one configuration parameter. In one example, the ML algorithm is trained based on the at least one site specific parameter and the one configuration parameter in one step, not trained first based on the site specific parameter, then afterwards trained based on the configuration parameter. However, this is also not excluded from the scope of the present disclosure since the second training can be implemented to not reverse or worsen the learning of the ML algorithm from the first training.

In a variation of the above example, the at least one configuration parameter comprises information about at least one of: a model type of a tower of the wind turbine, a model type of at least one rotor blade of the wind turbine, a control system type of the wind turbine. A model type of a tower of the wind turbine comprises for example information about the height and/or width of the tower. A model type of at least one rotor blade comprises for example information on the length and/or thickness and/or aerodynamic profile and/or configuration, in specific one part or multiple parts, of at least one or all rotor blades of the wind turbine. A control system type comprises for example information about the modes the wind turbine is operated in, functions of the wind turbine, in specific pitch functions, and/or simulation and/or adaptation tools of the wind turbine.

In one example, also aerodynamic attachments to the wind turbine, as for example serrations or vortex generators or flaps are considered in the at least one configuration parameter.

Considering at least one configuration parameter besides at least one site specific parameter increases the accuracy of clustering wind turbines with comparable conditions and improves the comparison of the wind turbine with the specific cluster.

In one aspect of the present disclosure, the cluster performance index is an annual cluster performance index, in specific, providing information about a mean annual energy production, AEP, of the wind turbines comprised in a cluster, and the wind turbine performance index is an annual wind turbine performance index, in specific, providing information about an AEP of the wind turbine.

In one example, the annual cluster performance index is based on data covering one year of operation of the wind turbines comprised in the cluster and the annual wind turbine performance index is based on data covering one year of operation of the wind turbine. Alternatively data from shorter operation periods of the wind turbines comprised in a cluster and/or the wind turbine is extrapolated to one year to get the annual cluster performance index and/or the annual wind turbine performance index, respectively.

An annual wind turbine performance index and an annual cluster performance index has the advantage that potential deviations in the site conditions of the wind turbines, for example due to climate and/or weather events, for example seasons (e.g., summer and winter), and/or for example storms, dries and/or extreme temperatures, are considered. In case of extrapolated annual performance indices, the longer the period during which the data was collected, the better, since it becomes more likely to record potential deviations in the site conditions.

According to a further aspect of the present disclosure, a computer program (computer-readable instructions) when executed by a computer is configured to perform a method according to the first aspect of the present disclosure.

For this, the computer program may comprise functions to acquire data from servers and/or memories and/or sensors, in specific directly from one or more wind turbines. The computer program may comprise functions to generate signals to one or more displays and/or one or more sound generating means. The computer may have one or more memories to store the computer program and one or more processors to execute the computer program to perform a method according to the first aspect of the present disclosure including implementing functions to acquire data from servers and/or memories and/or sensors, in specific directly from one or more wind turbines.

According to a further aspect of the present disclosure, a training data set for training a machine learning algorithm to cluster a plurality of wind turbines into a plurality of clusters of wind turbines with comparable conditions based on the training dataset, in specific based on at least one site specific parameter, each of the plurality of clusters of wind turbines comprising at least two wind turbines is provided, wherein the training data set comprises data on each of the plurality of wind turbines, in specific data comprising the at least one site specific parameter for each of the plurality of wind turbines.

In one example, this training data set results from the step of preparing a dataset based on the acquired parameters according to the first aspect of the present disclosure.

According to a further aspect of the present disclosure, a performance evaluation system for evaluating the performance of a wind turbine is provided, comprising: a first acquisition unit configured to acquire at least one power production parameter and at least one site specific parameter for each of a plurality of wind turbines for each of a plurality of days, a preparation unit configured to prepare a dataset based on the parameters, acquired by the first acquisition unit, a training unit configured to train a machine learning algorithm to cluster the plurality of wind turbines into a plurality of clusters of wind turbines with comparable conditions based on the dataset, in specific based on the at least one site specific parameter, each of the plurality of clusters of wind turbines comprising at least two wind turbines, a cluster unit configured to cluster the plurality of wind turbines with the trained machine learning algorithm into a plurality of clusters of wind turbines, a second acquisition unit configured to acquire the at least one site specific parameter for the wind turbine, an identification unit configured to identify a specific cluster from the plurality of clusters with comparable conditions to the wind turbine based on the at least one site specific parameter of the wind turbines comprised in the specific cluster and the at least one site specific parameter of the wind turbine, a first determination unit configured to determine a cluster performance index of the specific cluster based on the at least one power production parameter of the wind turbines comprised in the specific cluster, a third acquisition unit configured to acquire the at least one power production parameter of the wind turbine, a second determination unit configured to determine a wind turbine performance index of the wind turbine based on the at least one power production parameter of the wind turbine, an evaluation unit configured to evaluate the performance of the wind turbine by comparing the wind turbine performance index of the wind turbine to the cluster performance index of the specific cluster.

The specification, example embodiments, effects and examples of a method according to the first aspect of the present disclosure also apply to the respective units of the performance evaluation system. In case in some embodiments of such a method, a method step is described that cannot be executed by an above unit, the performance evaluation system comprises one or more additional units configured to perform the respective steps.

In one aspect of the present disclosure, one acquisition unit is configured to perform the tasks of the above first acquisition unit, the second acquisition unit and the third acquisition unit. Likewise, in an embodiment, the first determination unit and the second determination unit are combined in one determination unit.

The performance evaluation system may comprise one or more interface to receive and send data, in specific receive data from a server and/or a memory and/or one or more wind turbines, such as one or more sensors of one or more wind turbines.

Features of examples of the present disclosure are defined, in particular, in the dependent claims, while further advantageous features, embodiments and implementations are apparent to the skilled person from the above explanation and the following discussion.

### BRIEF DESCRIPTION OF THE DRAWINGS

In the following, the present disclosure is further elucidated and exemplified under reference to embodiments illustrated in the attached drawings, in which

FIG. 1 shows a schematic representation of a wind turbine.

FIG. 2 shows a schematic representation of a wind farm.

FIG. 3 shows a schematic flow diagram of an exemplary embodiment of a method according to the present disclosure.

### DETAILED DESCRIPTION

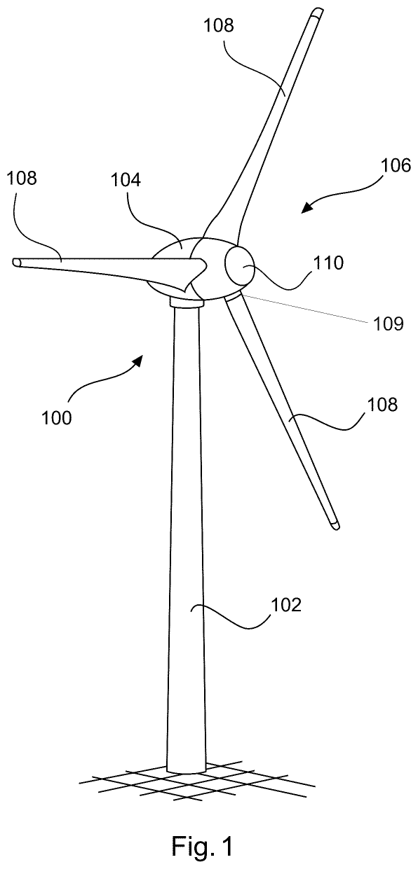

FIG. 1 shows a schematic representation of a wind turbine according to the present disclosure. The wind turbine 100 has a tower 102 and a nacelle 104 on the tower 102. An aerodynamic rotor 106 with three rotor blades 108 and a spinner 110 is provided on the nacelle 104. During operation of the wind turbine, the aerodynamic rotor 106 is set in rotation by the wind and thus also rotates an electrodynamic rotor or rotor of a generator, which is coupled directly or indirectly to the aerodynamic rotor 106. The electrical generator is arranged in the nacelle 104 and generates electrical energy. The pitch angles of the rotor blades 108 can be changed by pitch motors on the rotor blade roots 109 of the respective rotor blades 108.

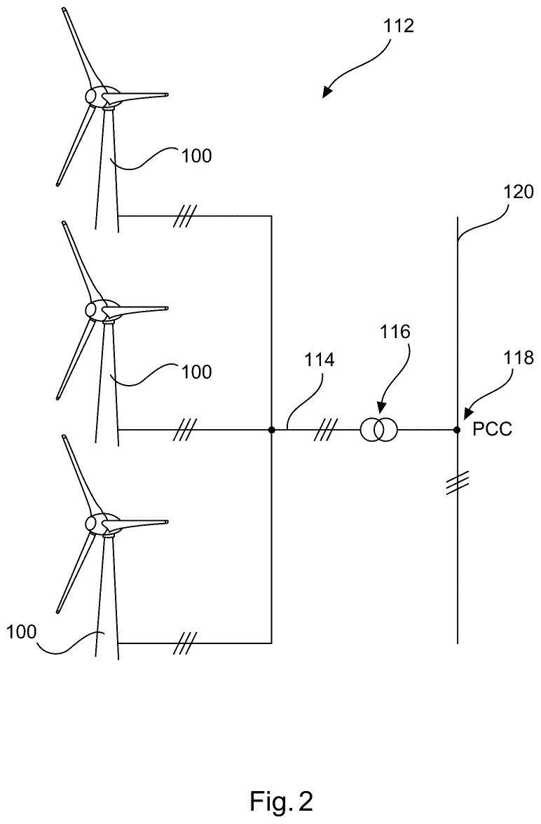

FIG. 2 shows a wind farm 112 with, by way of example, three wind turbines 100, which may be identical or different. The three wind turbines 100 are thus representative of basically any number of wind turbines of a wind farm 112. The wind turbines 100 provide their power, in particular the generated power, via an electrical farm grid 114. The currents or power generated by the individual wind turbines 100 are added together and a transformer 116 is usually provided, which transforms the voltage in the park upwards in order to then feed it into the supply grid 120 at the feed-in point 118, which is also generally referred to as the PCC. FIG. 2 is only a simplified representation of a wind farm 112. For example, the farm grid 114 may be designed differently, for example by also having a transformer at the output of each wind turbine 100, to name just one other embodiment example.

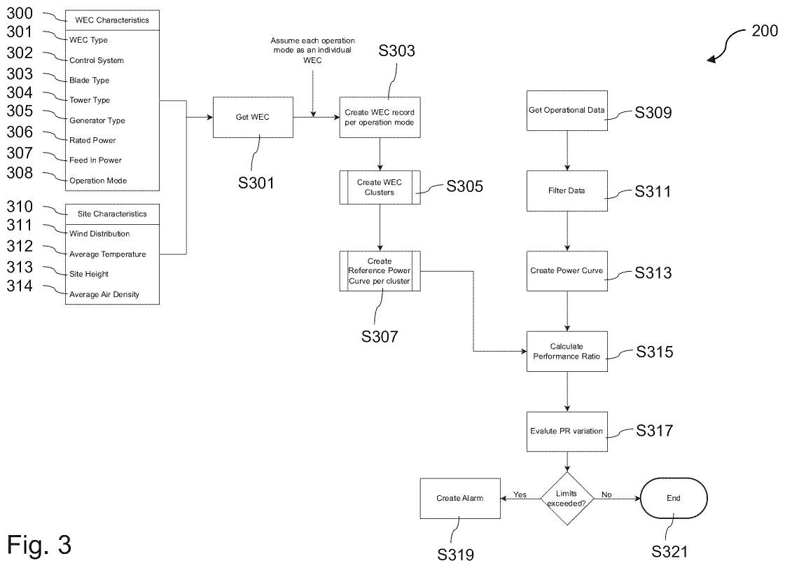

FIG. 3 shows a schematic flow diagram of an exemplary embodiment of a method 200 according to the present disclosure. In this exemplary embodiment, the method 200 acquires in a step S301 input parameters, in specific wind turbine characteristic parameters 300 and site characteristics 310 of a plurality of wind turbines.

The wind turbine characteristic parameters 300 acquired in this example are the wind turbine type 301, the control system 302 (name or type or other identification), the blade type 303 of the rotor blades of the wind turbines, the tower type 304, the generator type 305, the rated power 306, the feed in power 307 and the operation mode 308.

The site characteristic parameters 310 acquired in this example are wind distribution 311, average temperature 312, site height 313 and average air density 314. In a further step S303, a record of the acquired wind turbines is created, for example a database comprising the acquired data of the wind turbines.

In this example, each operation mode of the wind turbines is assumed as an individual wind turbine in this step. The wind turbine record therefore comprises a larger amount of wind turbines than the number of wind turbines for which data was provided as input.

In a further step S305, clusters of wind turbines with comparable conditions are created based on the wind turbine record and in specific the wind turbine characteristic parameters 300 and the site characteristic parameters 310. This step comprises the usage of a trained ML algorithm that clusters the wind turbines comprised in the wind turbine record. In specific, this step also comprises training the ML algorithm.

In a further step S307, reference power curves per cluster are created that provide information about the average power production of the wind turbines comprised in each cluster.

The further steps S309, S311, S313 may be executed before, parallel to, or after the steps S301, S303, S305 and S307.

In a step S309 the operational data of a wind turbine to be evaluated are acquired. For a good evaluation, the parameters acquired for the wind turbines should be the same as the parameters acquired for the plurality of wind turbines. Alternatively the input parameters of the plurality of wind turbines could be derived from the input parameters of the wind turbine in order to improve the identification of a specific cluster for the wind turbine.

This is done for example in a further step S311 that filters the data acquired for the wind turbine to derive parameters for sorting the wind turbine to a specific cluster, such as parameter values for the parameters that were acquired as input parameters for the plurality of wind turbines. In this step S311 or in a further step, a specific cluster is identified for the wind turbine with comparable conditions, based in specific on the wind turbine characteristic parameters 300 and the site characteristic parameters 310 as well as the filter data that is provided by filtering the data.

In a further step S313, a power curve is determined for the wind turbine based on the filtered data and/or the operational data acquired.

In a further step S315 a performance ratio of the wind turbine is calculated based on the power curve of the wind turbine and the reference power curve of the specific cluster that was identified to have comparable conditions to the wind turbine.

In a further step S317, the performance ratio, PR, is evaluated. This step takes predetermined limits regarding the PR into account.

If one of these limits is exceeded, the method 200 generates an alarm in a next step S319.

If the limits are not exceeded, the method ends in a step S321.

Alternatively to an end, the method 200, in specific the steps S309, S311, S313, S315, S317 and potentially the steps S319 or S321 are repeated periodically.

The alarm created in step S319 is for example a notification on a display, a sound and/or a requested user interaction for example with a computer.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Reference signs

| | |
|---|---|
| 100 | wind turbine |
| 102 | tower |
| 104 | nacelle |
| 106 | rotor |
| 108 | rotor blade |
| 109 | rotor blade root |
| 110 | spinner |
| 112 | wind farm |
| 114 | farm grid |
| 116 | transformer |
| 118 | feed-in point |
| 120 | supply grid |
| 200 | method |
| 300 | wind turbine characteristic parameters |
| 301 | wind turbine type |
| 302 | control system |
| 303 | blade type |
| 304 | tower type |
| 305 | generator type |
| 306 | rated power |
| 307 | feed in power |
| 308 | operation mode |
| 310 | site characteristic parameters |
| 311 | wind distribution |
| 312 | average temperature |
| 313 | site height |
| 314 | average air density |

1. A method for evaluating a performance of a wind turbine, comprising:
acquiring, for each of a plurality of wind turbines, at least one corresponding power production parameter and at least one corresponding site specific parameter for each of a plurality of days;
preparing a dataset based on the at least one corresponding power production parameter and the at least one corresponding site specific parameter;
training a machine learning algorithm to cluster the plurality of wind turbines into a plurality of clusters of wind turbines with comparable conditions based on the dataset, each of the plurality of clusters of wind turbines including at least two wind turbines,
clustering the plurality of wind turbines with the trained machine learning algorithm into the plurality of clusters of wind turbines;
identifying a specific cluster from the plurality of clusters with comparable conditions to the wind turbine based on corresponding site specific parameters of wind turbines in the specific cluster and the at least one corresponding site specific parameter of the wind turbine;
determining a cluster performance index of the specific cluster based on the at least one corresponding power production parameter of the wind turbines comprised in the specific cluster;
determining a wind turbine performance index of the wind turbine based on the at least one corresponding power production parameter of the wind turbine; and
evaluating a performance of the wind turbine by comparing the wind turbine performance index of the wind turbine to the cluster performance index of the specific cluster.

2. The method according to claim 1, wherein the machine learning algorithm is an unsupervised machine learning algorithm.

3. The method according to claim 2, wherein the machine learning algorithm is one of:
a k-means algorithm,
a density based spatial clustering of applications with noise,
an agglomerative clustering, and
a bisecting k-means algorithm.

4. The method according to claim 1, wherein the at least one corresponding site specific parameter comprises information about at least one of:
a site height,
a wind distribution at a site,
an average air density at the site,
an average temperature at the site, and
an average turbulence intensity at the site.

5. The method according to claim 1, wherein training the machine learning algorithm comprises:
optimizing a cluster size of the plurality of clusters of wind turbines.

6. The method according to claim 1, further comprising:
evaluating the clusters of wind turbines generated by the machine learning algorithm; and
repeating the training of the machine learning algorithm until the clusters of wind turbines generated by the machine learning algorithm satisfy predetermined requirements.

7. The method according to claim 1, wherein evaluating the performance of the wind turbine comprises;
determining a variation of the wind turbine performance index of the wind turbine to the cluster performance index of the specific cluster.

8. The method according to claim 7, further comprising:
generating a signal if the variation of the wind turbine performance index of the wind turbine to the cluster performance index of the specific cluster is higher than a predetermined threshold value, wherein the signal is one of a flag or an alarm.

9. The method according to claim 8, wherein the predetermined threshold value is a cluster dependent threshold value that is preset for each of the plurality of clusters of wind turbines as a function of a cluster performance index of a respective cluster.

10. The method according to claim 1, further comprising:
acquiring, for each of the plurality of wind turbines, at least one corresponding configuration parameter for each of the plurality of days;
further training the machine learning algorithm to cluster the plurality of wind turbines into the plurality of clusters of wind turbines with comparable conditions based on the at least one corresponding configuration parameter;
acquiring the at least one corresponding configuration parameter for the wind turbine; and
further identifying the specific cluster from the plurality of clusters with comparable conditions to the wind turbine based on corresponding configuration parameters of the wind turbines in the specific cluster and the at least one corresponding configuration parameter of the wind turbine.

11. The method according to claim 10, wherein the at least one configuration parameter comprises information about at least one of:
a model type of a tower of the wind turbine,
a model type of at least one rotor blade of the wind turbine, and
a control system type of the wind turbine.

12. The method according to claim 1, wherein the cluster performance index is an annual cluster performance index that indicates information on a mean annual energy production of the wind turbines comprised in a cluster, and the wind turbine performance index is an annual wind turbine performance index that provides information about an annual energy production of the wind turbine.

13. (canceled)

14. The method according to claim 1, wherein the machine learning algorithm is trained using a training data set wherein the training data set is based on the dataset and includes data on each of the plurality of wind turbines including the at least one site specific parameter for each of the plurality of wind turbines.

15. A performance evaluation system configured to evaluate the performance of a wind turbine, comprising:
one or more memories having computer-readable instructions stored therein; and
one or more processors configured to execute the computer-readable instructions to:
acquire, for each of a plurality of wind turbines, at least one corresponding power production parameter and at least one corresponding site specific parameter for each of a plurality of days;
prepare a dataset based on the at least one corresponding power production parameter and at least one corresponding site specific parameter;
train a machine learning algorithm to cluster the plurality of wind turbines into a plurality of clusters of wind turbines with comparable conditions based on the dataset, each of the plurality of clusters of wind turbines comprising at least two wind turbines;
cluster the plurality of wind turbines with the trained machine learning algorithm into the plurality of clusters of wind turbines;
identify a specific cluster from the plurality of clusters with comparable conditions to the wind turbine based on corresponding site specific parameters of the wind turbines in the specific cluster and the at least one corresponding site specific parameter of the wind turbine;
determine a cluster performance index of the specific cluster based on the at least one corresponding power production parameter of the wind turbines in the specific cluster;
determine a wind turbine performance index of the wind turbine based on the at least one corresponding power production parameter of the wind turbine; and
evaluate a performance of the wind turbine by comparing the wind turbine performance index of the wind turbine to the cluster performance index of the specific cluster.

16. The performance evaluation system according to claim 15, wherein the one or more parameter are further configured to execute the computer-readable instructions to:
acquire, for each of the plurality of wind turbines, at least one corresponding configuration parameter for each of the plurality of days;
further train the machine learning algorithm to cluster the plurality of wind turbines into the plurality of clusters of wind turbines with comparable conditions based on the at least one corresponding configuration parameter;
acquire the at least one corresponding configuration parameter for the wind turbine; and
further identify the specific cluster from the plurality of clusters with comparable conditions to the wind turbine based on corresponding configuration parameters of the wind turbines in the specific cluster and the at least one corresponding configuration parameter of the wind turbine.

17. The performance evaluation system according to claim 15, wherein the one or more processors are configured to execute the computer-readable instructions to evaluate the performance of the wind turbine by:
determining a variation of the wind turbine performance index of the wind turbine to the cluster performance index of the specific cluster.

18. The performance evaluation system according to claim 17, wherein the one or more processors are configured to execute the computer-readable instructions to:
generate a signal if the variation of the wind turbine performance index of the wind turbine to the cluster performance index of the specific cluster is higher than a predetermined threshold value, wherein the signal is one of a flag or an alarm.

19. One or more non-transitory computer-readable media comprising computer-readable instructions, which when executed by one or more processors of a performance evaluation system configured to evaluate the performance of a wind turbine, cause the performance evaluation system to:
acquire, for each of a plurality of wind turbines, at least one corresponding power production parameter and at least one corresponding site specific parameter for each of a plurality of days;
prepare a dataset based on the at least one corresponding power production parameter and at least one corresponding site specific parameter;
train a machine learning algorithm to cluster the plurality of wind turbines into a plurality of clusters of wind turbines with comparable conditions based on the dataset, each of the plurality of clusters of wind turbines comprising at least two wind turbines,
cluster the plurality of wind turbines with the trained machine learning algorithm into the plurality of clusters of wind turbines,
identify a specific cluster from the plurality of clusters with comparable conditions to the wind turbine based on corresponding site specific parameters of the wind turbines in the specific cluster and the at least one corresponding site specific parameter of the wind turbine;
determine a cluster performance index of the specific cluster based on the at least one corresponding power production parameter of the wind turbines in the specific cluster;
determine a wind turbine performance index of the wind turbine based on the at least one corresponding power production parameter of the wind turbine;
evaluate a performance of the wind turbine by comparing the wind turbine performance index of the wind turbine to the cluster performance index of the specific cluster.

20. The one or more non-transitory computer-readable media according to claim 19, wherein execution of the computer-readable instructions by the one or more processors further cause the performance evaluation system to:
acquire, for each of the plurality of wind turbines, at least one corresponding configuration parameter for each of the plurality of days;
further train the machine learning algorithm to cluster the plurality of wind turbines into the plurality of clusters of wind turbines with comparable conditions based on the at least one corresponding configuration parameter;
acquire the at least one corresponding configuration parameter for the wind turbine; and
further identify the specific cluster from the plurality of clusters with comparable conditions to the wind turbine based on corresponding configuration parameters of the wind turbines in the specific cluster and the at least one corresponding configuration parameter of the wind turbine.

21. The one or more non-transitory computer-readable media according to claim 19, wherein execution of the computer-readable instructions by the one or more processors further cause the performance evaluation system to evaluate the performance of the wind turbine by:
determining a variation of the wind turbine performance index of the wind turbine to the cluster performance index of the specific cluster; and
generating a signal if the variation of the wind turbine performance index of the wind turbine to the cluster performance index of the specific cluster is higher than a predetermined threshold value, wherein the signal is one of a flag or an alarm.
